(19) United States
(12) Patent Application Publication
(10) Pub. No.: US 2023/0230030 A1
(43) Pub. Date: Jul. 20, 2023

(54) IMAGE ANALYSIS OF PRODUCTS IN A RETAIL STORE

(71) Applicant: Snap2Insight Inc., Portland, OR (US)

(72) Inventors: Praveen Gopalakrishnan, Portland, OR (US); Balakumaran Nandagopal, Bengaluru (IN); Gautam Malu, Hyderabad (IN); Rahil Patel, Kolkata (IN); Renish Pynadath, Bengaluru (IN)

(21) Appl. No.: 17/578,484

(22) Filed: Jan. 19, 2022

(51) Int. Cl. G06Q 10/08; G06Q 10/06; G06T 5/50

(52) U.S. Cl. CPC G06Q 10/087; G06Q 10/06311; G06Q 10/06315; G06T 5/50

(57) ABSTRACT

In some aspects, an edge computing system may receive, a plurality of images. An image in the plurality of images may be associated with products in a retail store. The edge computing system may select a subset of images in the plurality of images based on spatial contextual data associated with each image in the plurality of images, a level of redundancy between images in the plurality of images, and temporal contextual data associated with each image in the plurality of images. The edge computing system may transmit, to a cloud computing system, the subset of images for image analysis.

### CROSS REFERENCE TO RELATED APPLICATION

This Patent Application claims priority to U.S. Provisional Pat. Application No. 63/138,937, filed on Jan. 19, 2021, entitled “IMAGE ANALYSIS OF PRODUCTS IN A RETAIL STORE,” and assigned to the assignee hereof. The disclosure of the prior Application is considered part of and is incorporated by reference into this Patent Application.

### BACKGROUND

Retail stores are often large areas of space having a wide variety of products for sale. Retail stores may include dozens of aisles, and an aisle may include shelfs of products. Retail stores may also include larger products that are not on shelfs. Retail stores may be separated into various sections, such as groceries, pharmacy, garden, home, clothing, electronics, etc.

### SUMMARY

In some aspects, a method includes receiving, at an edge computing system, a plurality of images, wherein an image in the plurality of images is associated with products in a retail store; selecting, at the edge computing system, a subset of images in the plurality of images based on spatial contextual data associated with each image in the plurality of images, a level of redundancy between images in the plurality of images, and temporal contextual data associated with each image in the plurality of images; and transmitting, from the edge computing system to a cloud computing system, the subset of images for image analysis.

In some aspects, a method includes receiving, at a cloud computing system, images of a retail store; identifying, from the images and based on a model, products with low confidence scores; forming, from the products, a cluster of products having low confidence scores based on a level of similarity between the cluster of products; providing, to a developer system, an indication of the cluster of products; receiving, from the developer system, an annotation associated with the cluster of products, wherein the annotation provides product information for the cluster of products; and updating the model based on the annotation associated with the cluster of products to obtain an updated model.

In some aspects, a method includes receiving, at a cloud computing system, a plurality of images of a retail store that includes a first image and a second image; identifying a product indicated in the first image, wherein the product is associated with a key point; identifying the key point associated with the product in the second image, wherein the key point in the second image indicates an overlapping region between the first image and the second image; combining the first image and the second image based on the key point associated with the product, to produce a combined image; and performing an image analysis on the combined image.

### BRIEF DESCRIPTION OF THE DRAWINGS

FIGS. 1-4 are diagrams of an example implementation relating to image analysis of products in a retail store.

FIG. 5 is a diagram of an example environment in which systems and/or methods described herein may be implemented.

FIG. 6 is a diagram of example components of one or more devices of FIG. 5.

FIGS. 7-9 are flowcharts of example processes relating to image analysis of products in a retail store.

### DETAILED DESCRIPTION

The following detailed description of example implementations refers to the accompanying drawings. The same reference numbers in different drawings may identify the same or similar elements.

Retail stores, such as physical retail stores, are often large areas of space having a wide variety of products for sale. However, often times, products being offered for sale in the retail store may be subjected to various problems, such as being out-of-stock or low inventory, being missing, being misplaced, etc., which may result in billions of dollars of lost sales opportunity to retail stores and product manufacturers. Store employees may walk down aisles and/or areas of the retail store in order manually identify problems associated with the products. However, this manual approach may be time consuming and labor intensive.

One computer-implemented approach to mitigating this problem is capturing images of retail shelves and/or product areas, and analyzing the images to identify product problems based on the images. The images may be analyzed using models based on artificial intelligence, machine learning, computer vision, image recognition, heuristic rules, and/or related techniques to identify products that are present or not present in the retail store, as well as the problems associated with the products.

However, even with this computer-implemented approach, several problems currently exist. For example, the images may be captured using various types of electronic devices, such as mobile phones, tablet computers, etc. These electronic devices may be carried by users in the retail store. In some cases, the electronic devices may be fixed cameras that are dispersed throughout the retail store. The images may also be captured using robotic devices, that may or may not include autonomous moving capabilities. Such robotic devices may move around the retail store and capture images of products in the retail store. As a result, large amounts of images may be generated, and analyzing the large amounts of images may consume a relatively large amount of network bandwidth, memory, processing, etc. Further, often a relatively large portion of images may overlap with other images and/or have redundant data as compared to other images, so analyzing a small portion of the images may be sufficient.

Another problem is that when new products are offered for sale in retail stores, images captured of these new products may result in image analysis that is of low confidence. In other words, existing models may not yet be trained to recognize the new products captured in the images, so as a result, image analysis results may be of low confidence. However, new products are often sold in retail stores, so an inability to identify, classify, and/or flag previously non-trained products or new products may be disadvantageous. Further, frequent changes to product packaging are common, even though a certain product might not be considered new. However, an inability to identify, classify, and/or flag existing products with new packaging may be disadvantageous.

Another problem is that images taken of retail shelves and/or product areas may include different degrees of overlap between successive photos. In some cases, images of a given shelf fixture or product area may be combined or stitched together to form a composite image. Analysis may be performed on the composite image to yield more accurate image recognition results, as compared to analysis performed on multiple images separately. However, existing image stitching techniques are not suitable for images associated with retail shelves in the retail store, due to various complexities associated with the retail shelves. For example, the many similarities between adjacent products on a retail shelf (e.g., similar packaging dimensions of products, similar company logos on the products, etc.) may result in inaccurate image stitching, in which products included in separate images may be accidentally removed when stitching together the separate images. Further, different fixture types in the retail store may lead to inaccuracy when stitching together multiple images with products placed on the different fixture types.

In some aspects described herein, to solve the problems described above, as well as related technical problems of how to intelligently reduce a number of images for analysis, how to efficiently flag new products and/or existing products with new product packaging that have not been used to train a model, and how to stitch together multiple images of products having similar features and across different fixture types, various technical solutions are described herein. For example, a technical solution is described herein for reducing the number of images for analysis based on spatial contextual data associated with the images, levels of redundancy between the images, and temporal contextual data associated with the images. Further, a technical solution is described herein for forming clusters of related products with low confidence scores, and assigning an annotation to related products of a given cluster. Further, a technical solution is described herein for combining images based on products identified in the images and key points associated with the products to form a combined image, and then performing image analysis on the combined image.

In some aspects, reducing the number of images for analysis may reduce network bandwidth, reduce an amount of storage usage, and/or reduce an amount of processing usage. In some aspects, forming the clusters of related products may simplify generating annotations for new products or existing products with new packaging, since a same annotation may be applied to all products of a given cluster. In some aspects, combining multiple images of products based on key points associated with the products may allow accurate stitching of images of retail shelves containing a plurality of products, which are often similar to discernable features and may only be distinguished by specific product identifiers.

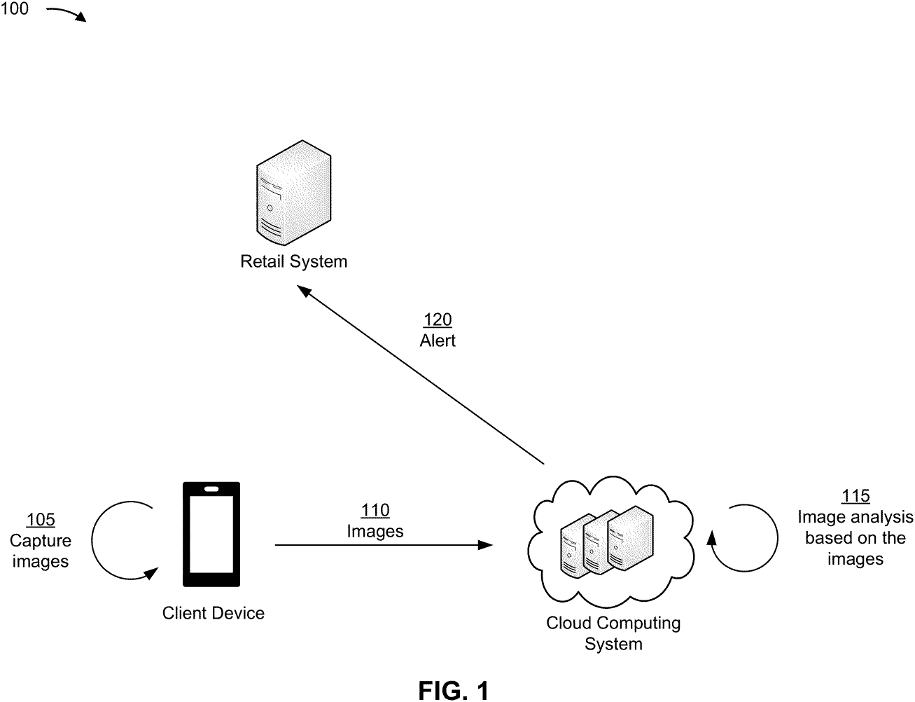

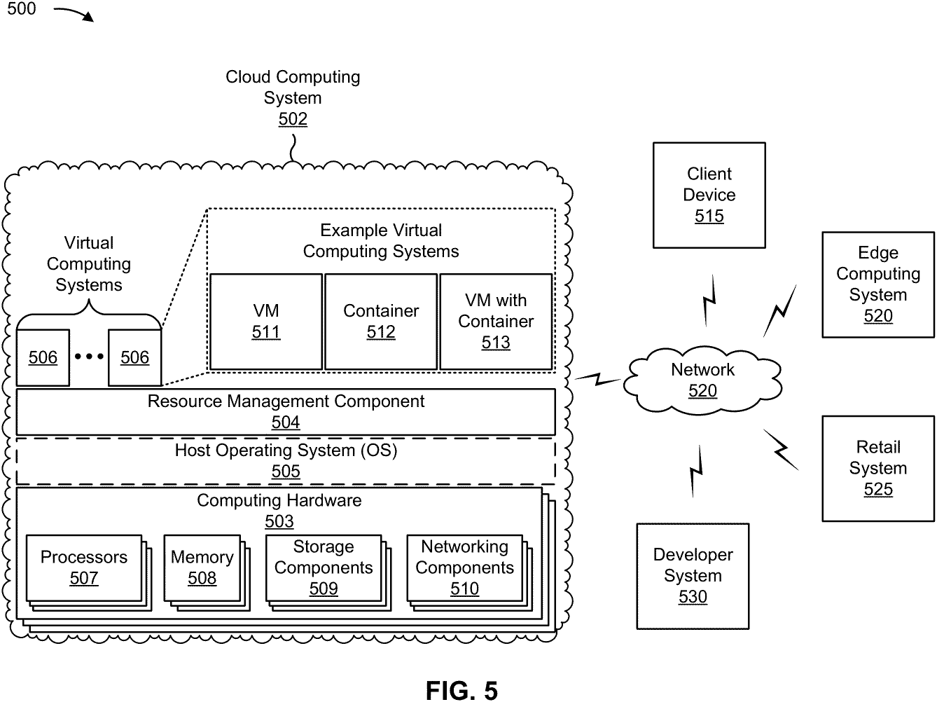

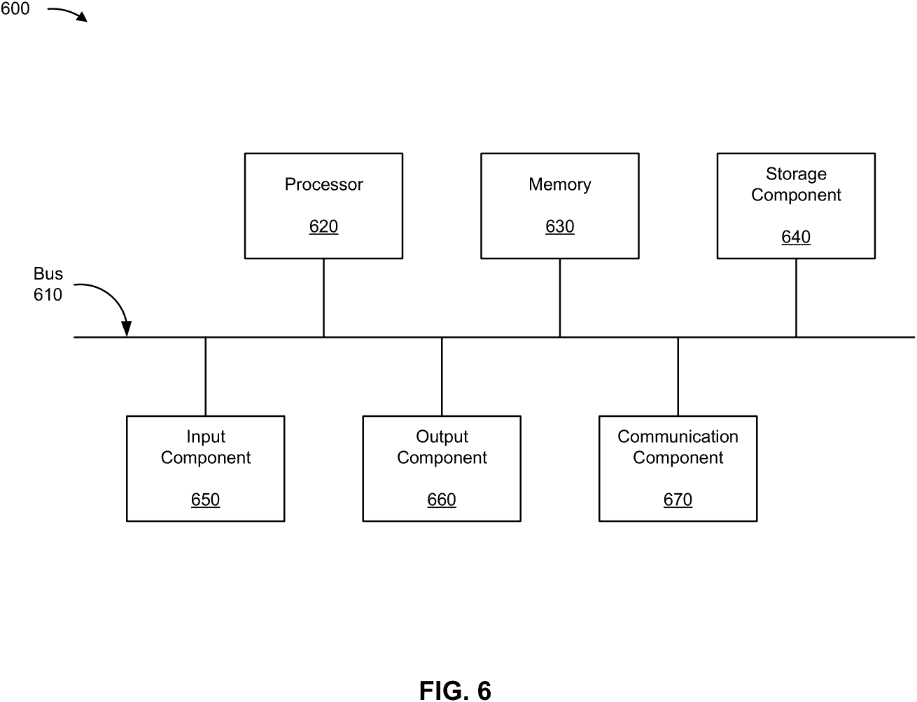

FIG. 1 is a diagram of an example implementation 100 relating to image analysis of products in a retail store. As shown in FIG. 1, example implementation 100 includes a client device, an edge computing system, a cloud computing system, and a retail system. These devices are described in more detail in connection with FIGS. 5 and 6.

As shown by reference number 105, the client device may capture a plurality of images of a retail store. The images may be of products on retail shelves of the retail store, and/or products located in product areas of the retail store (e.g., near a checkout counter located in the retail store, in an open space of the retail store, etc.) In some aspects, the client device may be a mobile phone, which may be used by a user to capture the images of the retail store.

As shown by reference number 110, the client device may transmit the plurality of images to the cloud computing system, where the images may be associated with products in the retail store. The client device may transmit the images via a telecommunications network, or any other suitable mechanism.

As shown by reference number 115, the cloud computing system may perform an image analysis on the plurality of images. The cloud computing system may perform the image analysis using models based on artificial intelligence, machine learning, computer vision, image recognition, heuristic rules, and/or related techniques. The cloud computing system may identify products that are present or not present in the retail store (e.g., out-of-stock products), as well as problems associated with the products (e.g., missing products or misplaced products).

As shown by reference number 120, the cloud computing system may transmit an alert based on the image analysis. The cloud computing system may transmit the alert to the retail system. The retail system may be an on-premise system of the retail store. The alert may notify a manager of the retail store of the products that are present or not present, the problems associated with the products, etc.

As indicated above, FIG. 1 is provided as an example. Other examples may differ from what is described with respect to FIG. 1.

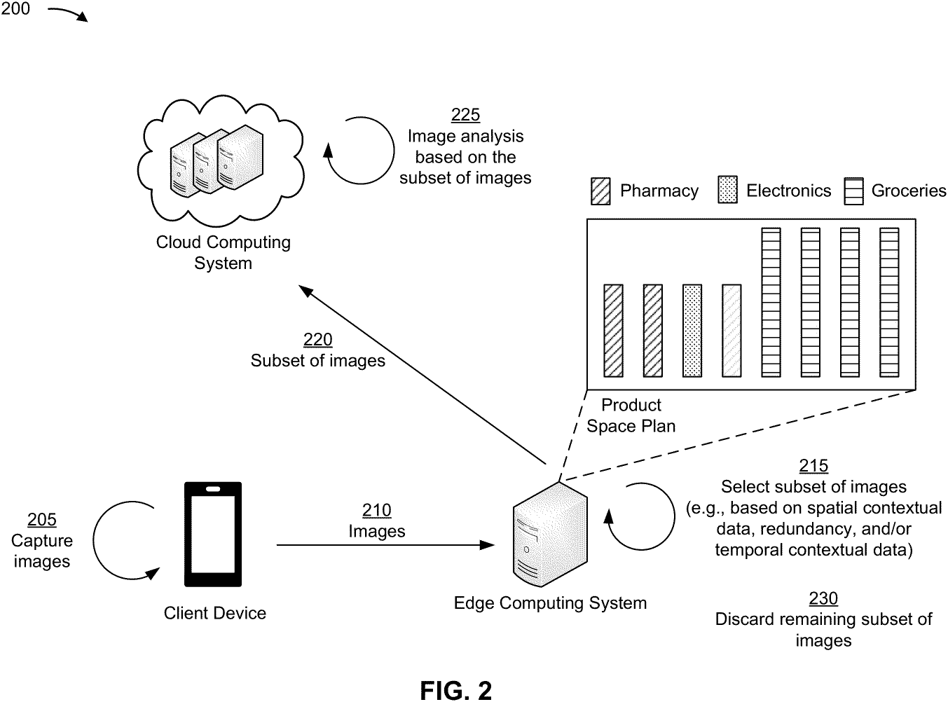

FIG. 2 is a diagram of an example implementation 200 relating to image analysis of products in a retail store. As shown in FIG. 2, example implementation 200 includes a client device, an edge computing system, and a cloud computing system. These devices are described in more detail in connection with FIGS. 5 and 6.

As shown by reference number 205, the client device may capture a plurality of images of a retail store. The images may be of products on retail shelves of the retail store, and/or products located in product areas of the retail store (e.g., near a checkout counter located in the retail store, in an open space of the retail store, etc.) In some aspects, the client device may be a mobile phone, which may be used by a user to capture the images of the retail store. In some aspects, the client device may be a robotic device, which may move around the retail store and capture the images of the retail store. In some cases, the robotic device may autonomously move around the retail store and capture the images. Alternatively, the robotic device may be controlled by a user to move around the retail store and capture the images. The robotic device may move around the retail store at a certain speed and capture the images with a certain frequency (e.g., every one second, every two seconds, every five seconds, and so on).

In some aspects, the client device may capture other information associated with the images. For example, for each image, the client device may store corresponding spatial location data. In other words, the client device may associate the spatial location data for each captured image. The spatial location data may indicate a specific location (e.g., a location defined by X-Y coordinates) at which the image was captured within the retail store. The client device may capture the other information using various sensors of the client device, such as an inertial sensor, an accelerometer, etc. Additionally, the client device may store temporal context data for each image, which may indicate a time (e.g., a timestamp) associated with the image.

As shown by reference number 210, the client device may transmit the plurality of images to the edge computing system, where the images may be associated with products in the retail store. The client device may transmit the images, as well as corresponding spatial contextual data and/or temporal contextual data. The client device may transmit the images via a wireless local area network (WLAN), via a telecommunications network, via Bluetooth, or any other suitable mechanism. The edge computing system may be an on-premises with respect to the retail store. For example, the edge computing system may be located within the retail store. Additionally, the client device may transmit, to the edge computing device, spatial location data associated with each of the images. Alternatively, the edge computing system may be located separate from the retail store, but may be located closer to the retail store as compared to the cloud computing system to save network bandwidth.

In some aspects, the client device and the edge computing system may be a single device. For example, a robotic device that captures the images may provide edge computing with respect to the images as well.

As shown by reference number 215, the edge computing system may select a subset of images from the plurality of images based on the spatial contextual data associated with each image, levels of redundancy between images, and the temporal contextual data associated with each image. The edge computing system may select the subset of images to reduce the network bandwidth, memory, and/or computing associated with processing all of the images received from the client device.

In some aspects, the edge computing system may identify the spatial contextual data associated with each image. The spatial contextual data may indicate the relative spatial location within the retail store associated with each image. The edge computing system may discard images having relative spatial locations that do not satisfy a relative distance threshold in relation to other images having relative spatial locations. In other words, images that are within a certain virtual distance from each other may be assumed to have a relatively high amount of overlap between the images, so some of the images may be discarded. Relative spatial location data across images may be used to select images that are distinct enough in space to provide new information, with a minimal amount of overlap.

As an example, a first image may be associated with a first set of spatial location coordinates, a second image may be associated with a second set of spatial location coordinates, and a third image may be associated with a third set of spatial location coordinates. The first set of spatial location coordinates and the third set of spatial location coordinates may indicate that the first image and the third image cover adjacent retail shelves, and that the second set of spatial location coordinates overlaps with half of the first image and half of the second image. In this example, the second image may be discarded, and only the first image and the third image may be used. In other words, in this example, a relative distance threshold between the first image and the third image may be satisfied, but a relative distance threshold between the first image and the second image may not be satisfied, and a relative distance threshold between the second image and the third image may not be satisfied.

As another example, a robotic device may capture an image every two seconds and may move at one inch per second, based on spatial contextual data associated with the images. In this example, one of every five images may be used, and the remaining four images may be discarded, based on redundancy between the images. Thus, the spatial contextual data may be used in determine relative spatial locations of the images and a frequency of the images captured, which may be used to discard images that contain redundant information.

In some aspects, the edge computing system may identify the spatial contextual data associated with each image. The edge computing system may compare the spatial contextual data associated with each image to a product space plan associated with the retail store. The product space plan may indicate areas within the retail store associated with products and areas within the retail store that are not associated with products. The product space plan may indicate a layout of retail shelves within the retail store, as well as types of products associated with portions of the retail shelves. The edge computing system may discard images that correspond to areas within the retail store that are not associated with the products, based on comparing the spatial contextual data associated with the images to the product space plan.

As an example, the edge computing system may compare a set of spatial location coordinates associated with an image to the product space plan. When the set of spatial location coordinates corresponds to an area of the retail store having products, as indicated by the product space plan, the image may be at least temporarily retained for further processing. When the set of spatial location coordinates does not correspond to an area of the retail store having products, as indicated by the product space plan, the image may be discarded. For example, the robotic device may capture images of the entire retail store (e.g., which may include an entry way, a coffee shop located within the retail store, etc.), so images that do indicate any products may be discarded.

In some aspects, the edge computing system may determine a level of redundancy between images. The redundancy may indicate a level of overlap between the images. The edge computing system may discard images having levels of redundancy that do not satisfy a threshold in relation to other images in the plurality of images. In other words, the edge computing system may compare images and identify images having redundant information, such as information that is also found in at least one of the other images. In this case, the edge computing system may discard some of the images having the redundant information.

In some aspects, the edge computing system may identify the temporal contextual data associated with each image. The temporal contextual data may indicate the time associated with the image. The edge computing system may remove images associated with times that do not satisfy a threshold in relation to other images.

As an example, a first image of a spatial location within the retail store may be associated with a first timestamp. At a later time, a second image of the same spatial location within the retail store may be captured, and may be associated with a second timestamp. In this example, when a difference between the first timestamp and the second timestamp does not satisfy a threshold (e.g., the first and second images are taken too close in time), the second image may be discarded. At a later time, a third image of the same spatial location within the retail store may be captured, and may be associated with a third timestamp. In this example, when a difference between the first timestamp and the third timestamp satisfies the threshold (e.g., the first and third images are separated by a sufficient amount of time), the third image may be retained. Since products on retail shelves do not abruptly change from day to day, a configurable time threshold may be set, such that image are not taken too close in time together, thereby reducing network bandwidth, storage, and processing by reducing an overall number of images used for image analysis.

In some aspects, the edge computing system may select the subset of images based on customer criteria. The customer criteria may define a portion of the images that are to be retained, and/or a portion of the images that are to be discarded. In some cases, a customer may select to process a relatively high number of images to improve accuracy. In other cases, the customer may select to process fewer images to reduce network bandwidth, storage costs, processing costs, etc. The edge computing system may receive an indication of the customer criteria, and select the images accordingly based on the customer criteria.

As shown by reference number 220, the edge computing system may transmit the subset of images to the cloud computing system for image analysis. The subset of images may be a reduced number of images as compared to the plurality of images captured at the client device. The subset of images may be derived based on the spatial contextual data associated with each image, the levels of redundancy between images, and the temporal contextual data associated with each image.

As shown by reference number 225, the cloud computing system may perform the image analysis on the subset of images. The cloud computing system may perform the image analysis using models based on artificial intelligence, machine learning, computer vision, image recognition, heuristic rules, and/or related techniques. The cloud computing system may identify products that are present or not present in the retail store based on the image analysis (e.g., out-of-stock products), as well as problems associated with the products based on the image analysis (e.g., missing products or misplaced products). The cloud computing system may generate an alert based on the image analysis.

As shown by reference number 230, the edge computing system may discard a remaining subset of images. For example, images that are of less value based on the spatial contextual data, the levels of redundancy, and/or the temporal contextual data may be discarded, thereby reducing a storage load at the edge computing system.

As an example, the client device may capture 100 images of products in the retail store. The client device may send the 100 images to the edge computing system. The edge computing system may reduce the 100 images to 15 images based on the spatial contextual data, the levels of redundancy, and/or the temporal contextual data. The edge computing system may send the 15 images to the cloud computing system for image analysis. The edge computing system may discard the remaining 85 images.

As indicated above, FIG. 2 is provided as an example. Other examples may differ from what is described with respect to FIG. 2.

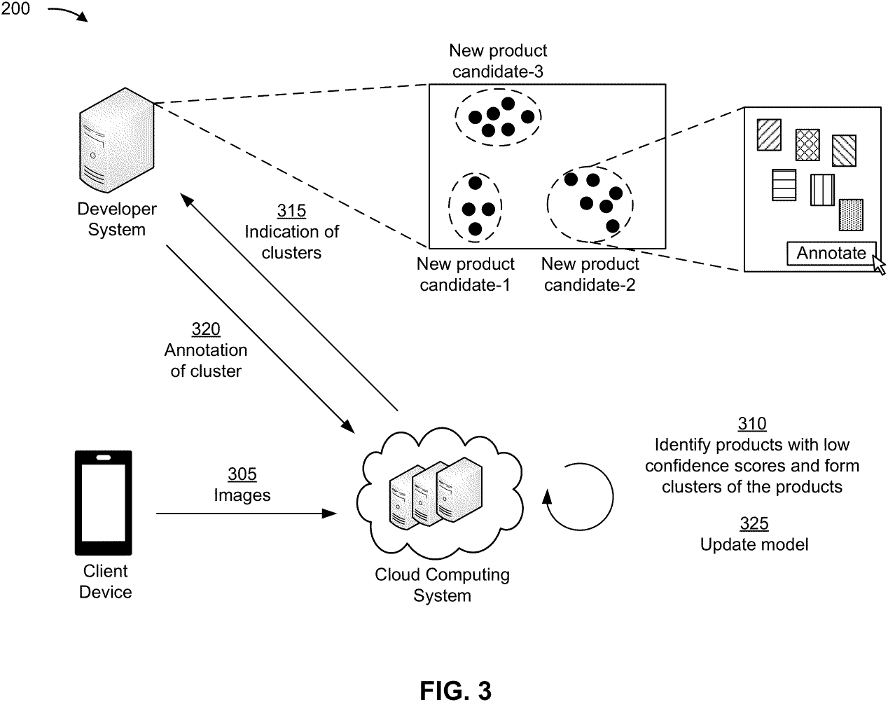

FIG. 3 is a diagram of an example implementation 300 relating to image analysis of products in a retail store. As shown in FIG. 3, example implementation 300 includes a client device, a cloud computing system, and a developer system. These devices are described in more detail in connection with FIGS. 5 and 6.

As shown by reference number 305, the cloud computing system may receive images of a retail store. The images may be associated with products sold in different retail stores across multiple geographic regions. In some aspects, the cloud computing system may receive the images from the client device, such as a mobile device or a robotic device. In some aspects, the cloud computing system may receive the images from the client device via an edge computing device. In other words, the client device may transmit the images to the edge computing device, and the edge computing system may forward the images to the cloud computing system.

In some aspects, the cloud computing system may analyze the images using models based on artificial intelligence, machine learning, computer vision, image recognition, heuristic rules, and/or related techniques. The cloud computing system may identify objects indicated in the images as products. In other words, the cloud computing system may determine objects indicated in the images that are products (e.g., cartons of milk, bags of chips, etc.), versus objects indicated in the images that are not products (e.g., retail shelves, light fixtures, etc.) Further, the cloud computing system may determine product identifiers associated with the products. For example, the cloud computing system may identify a product as a specific stock keeping unit (SKU) with a brand and a Universal Product Code (UPC) description.

In some aspects, for existing products, the models may be trained to recognize an object as a product, as well as determine product identifiers (e.g., an SKU, a brand, and a UPC description) associated with the product. For new products for which the models have not been previously trained, the cloud computing system may identify objects in the images as being the new products, but may be unable to determine the product identifiers associated with the new products. The new product may visually look dissimilar to existing products with which the models have been previously trained. For example, the new product may be associated with a new product brand or an existing product with a new packaging design. However, for a new product is visually similar to existing products with which the models have been previously trained (e.g., a new flavor with a similar packaging design, or a promotional package of an existing product), the cloud computing system may identify an object in the images as being the new product and may determine product identifiers associated with the new product, but the product identifiers may be associated with a low confidence score. In other words, since the models may have been previously trained on existing products that are similar to the new product but are not exactly the same as the new product, the cloud computing system may be able to infer the product identifiers associated with the new product, but with the low confidence score.

As shown by reference number 310, the cloud computing system may identify, from the images of the retail store and based on the models, products indicated in the images with low confidence scores. The products may be new products or existing products with new packaging, for which the models have not yet been trained. As a result, the cloud computing system may be able to estimate product identifiers associated with the products (e.g., an SKU, a brand, and a UPC description), but since the models may not yet have been trained on the new products or the existing products with the new packaging, the cloud computing system may assign the low confidence scores to the product identifiers associated with the products. In some aspects, the low confidence scores may be represented as a numerical value within a range, where a first end of the range corresponds to a low confidence as to an accuracy of the product identifiers determined for the product, and a second end of the range corresponds to a high confidence as to the accuracy of the product identifiers determined for the product.

In some aspects, the cloud computing system may form clusters of products having low confidence scores based on a level of similarity between products in the cluster of products. For example, the cloud computing system may identify a plurality of products that are associated with the low confidence scores, and from the plurality of products, the cloud computing system may identify clusters of related products. The related products may be associated with a same brand, a same packaging design, a same product name, a same product type, same product dimensions, a same product logo, etc. The cloud computing system may form clusters of products where each product in a given cluster may be related to other products in the given cluster.

As shown by reference number 315, the cloud computing system may provide an indication of the clusters of products to the developer system. The indication of the clusters of products may be a visual indication, which may be displayed via a user interface of the developer system. For example, the visual indication may include different clusters of related products. The related products may correspond to new product candidates. A cluster of related products may be selected via the user interface to view images associated with each product in the cluster.

As shown by reference number 320, the cloud computing system may receive, from the developer system, an annotation associated with a cluster of products. The developer system may receive the annotation via the user interface of the developer system, and the developer system may transmit the annotation to the cloud computing system. The annotation may provide product information for the cluster of products. The product information may identify the products in the cluster, and may include an SKU, a brand, and/or a UPC description associated with the products in the cluster.

As shown by reference number 325, the cloud computing system may update the model based on the annotation associated with the cluster of products. In other words, the annotation associated with the cluster of products may train the model to subsequently recognize products within that cluster. The cloud computing system may obtain an updated model that incorporates the annotation associated with the cluster of products.

In some aspects, at a later time, the cloud computing may system receive an image that includes a product associated with the cluster of products. The cloud computing system may identify the product based on the updated model. For example, the cloud computing system may perform an image analysis based on the updated model, to obtain product identifiers (e.g., an SKU, a brand, and/or a UPC description) associated with the product.

As an example, the cloud computing system may receive a plurality of images of products across numerous retail stores over a period of time. The cloud computing system may identify, from the images, 850 products with high confidence scores. In other words, the cloud computing system may have been previously trained to identify these products, so the cloud computing system may assign the high confidence scores to these products. On the other hand, the cloud computing system may identify 150 products with low confidence scores. In other words, the 150 products may be new products, and the cloud computing system may not have been previously trained to identify these new products. The cloud computing system may still estimate product identifiers associated with the 150 products, but the cloud computing system may assign the low confidence scores to the products. Further, in this example, the cloud computing system may identify different clusters of related products within the 150 products based on similarities between the 150 products. For example, the cloud computing system may identify a first cluster of 80 products that all relate to a cheesy nacho dip, a second cluster of 40 products that all relate to a lime-flavored soda, and a third cluster of 30 products that all relate to a medium roast coffee powder.

Continuing with the example, the cloud computing system may transmit, to the developer system, an indication of the three different clusters of related products. The developer system may display, via the user interface, a visualization of the three different clusters of related products. The user interface may include controls to attach an annotation to each of the three different clusters of related products. For example, the user interface may enable a first annotation to define the first cluster of products related to the cheesy nacho dip, a second annotation to define the second cluster of products related to the lime-flavored soda, and a third annotation to define the third cluster of products related to the medium roast coffee powder.

In some aspects, the visualization of different clusters of related products may enable an efficient annotation or labeling of products associated with the different clusters of related products. New products or existing products with new packaging are likely to be sold at multiple retail stores across multiple geographic regions, so receiving images of a same new product or a same existing product with new packaging may be common. The visualization may enable a user to efficiently identify clusters of related products, and assign a same annotation to products in the cluster (e.g., all products in the cluster) in one-shot. As a result, new products or existing products with new packaging may be efficiently identified and labeled, which may be used to update the model, such that subsequent images of the same products may be successfully analyzed by the cloud computing system.

In some aspects, clusters of related products with low confidence scores may infer that the products are genuine. For example, a single instance of a product that is partially torn, upside down, etc. may result in a low confidence score associated with that product. However, in this case, the product may be identified as an outlier because no cluster of related products are formed. On the other hand, when clusters of related products are formed based on images received from multiple retail stores and across multiple geographic regions, the related products may be inferred to be a genuinely new product or a genuine existing product with new packaging.

In some aspects, when identifying the products with the low confidence scores, the cloud computing system may compare a product package for a given product to a set of product packaging attributes. The set of product packaging attributes may be associated with a manufacturer of the given product and may indicate product packaging regions having an increased likelihood of providing product information, such as a product name and/or a product description. The cloud computing system may determine that a similarity level between the product package for the given product and the set of attributes does not satisfy a threshold, and thereby are to be assigned a low confidence score.

As an example, for certain manufacturers, some regions within a product package are the most likely to change for a new product offered by the manufacturer or for an existing product with new packaging that is offered by the manufacturer. The regions may include a header of the product package, a footer of the product package, etc. These regions may include a product name, product description, etc. A set of product packaging attributes may be defined for a particular manufacturer, which may indicate typical regions that are modified by that manufacturer when offering new products or updating product packaging. When a product is analyzed by the cloud computing system, and product identifiers are identified for the product, the cloud computing system may compare the product package of the product to the set of product packaging attributes associated with the manufacturer of the product. The cloud computing system may flag the product as having low confidence when the product packaging deviates by a defined amount from the set of product packaging attributes.

As indicated above, FIG. 3 is provided as an example. Other examples may differ from what is described with respect to FIG. 3.

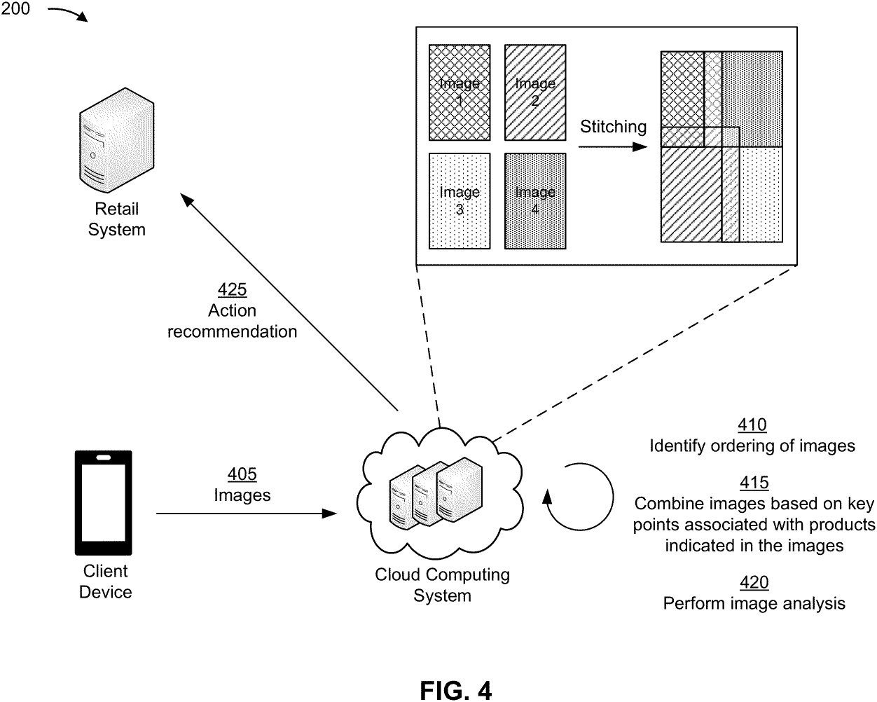

FIG. 4 is a diagram of an example implementation 400 relating to image analysis of products in a retail store. As shown in FIG. 4, example implementation 400 includes a client device, an edge computing system, a cloud computing system, and a developer system. These devices are described in more detail in connection with FIGS. 5 and 6.

As shown by reference number 405, the cloud computing system may receive images of a retail store, where the images may include a first image and a second image. The images may be associated with products sold in different retail stores across multiple geographic regions. In some aspects, the cloud computing system may receive the images from the client device, such as a mobile device or a robotic device. In some aspects, the cloud computing system may receive the images from the client device via an edge computing device. In other words, the client device may transmit the images to the edge computing device, and the edge computing system may forward the images to the cloud computing system.

As shown by reference number 410, the cloud computing system may determine an ordering associated with the images received from the client device. The cloud computing system may receive the images in a non-linear order, and the cloud computing system may sort the images based on a predicted ordering of the images. The cloud computing system may analyze the images, and determine redundancy between images that are in proximity to each other to determine the predicted ordering of the images. The cloud computing system may combine an order at which the images were captured and a sequence of overlapping information between the images to determine the predicted ordering of the images. The cloud computing system may analyze the images using models based on artificial intelligence, machine learning, computer vision, image recognition, heuristic rules, and/or related techniques.

In some aspects, the cloud computing system may determine an ordering associated with the first image and the second image based on an overlap in information between the first image and the second image. The ordering may indicate that the second image sequentially follows the first image, or vice versa.

As an example, the cloud computing system may receive five images represented by Image2, Image3, Image1, Image 5, and Image4. The cloud computing system may determine, based on an analysis of the five images to determine sequence(s) of overlapping information between the five images, that a predicted ordering is Image1, Image2, Image3, Image4, and Image5.

As shown by reference number 415, the cloud computing system may combine (or stitch) the images to produce a combined image. The cloud computing system may combine the images based on the ordering associated with the images. In other words, the cloud computing system may first determine the ordering associated with the images, and then combine the images together to produce the combined image. The combined image may be used to perform an image analysis, as opposed to separate images associated with the combined image.

In some aspects, the cloud computing system may combine the images based on products identified in the images and key points associated with the products, to produce the combined image. For example, the cloud computing system may identify a product indicated in the first image. The cloud computing system may identify by product by identifying an SKU associated with the product, a brand associated with the product, and/or a UPC description associated with the product. The cloud computing system may identify the product in the first image using models based on artificial intelligence, machine learning, computer vision, image recognition, heuristic rules, and/or related techniques. The cloud computing system may define the product indicated in the first image as a key point, which may be used when combining the first image with the second image. For example, the cloud computing system may identify the key point associated with the product in the second image, where the key point in the second image may be used to indicate an overlapping region between the first image and the second image. In other words, the key point may be used as an anchor to determine overlapping regions between the first image and the second image, and then to combine the first image and the second image while discarding or removing the overlapping regions.

As an example, the cloud computing system may receive four images from the client device. The cloud computing system may determine an ordering of the four images, such as Image1, Image2, Image3, and Image4. The cloud computing system may combine the four images and remove overlapping regions between the four images, to produce a combined image. The cloud computing system may combine the four images based on products identified in the images, which may be used as the key points when identifying and removing the overlapping regions between the four images. For example, the cloud computing system may identify a bag of potato chips in the first and second images, an iced tea beverage in the second and third images, and a package of mozzarella cheese in the second, third and fourth images. The cloud computing system may use the bag of potato chips, the iced tea beverage, and the package of mozzarella cheese as the key anchors when combining the four images. The combined image may include a single instance of the bag of potato chips, the iced tea beverage, and the package of mozzarella cheese.

In some aspects, the first image of the product may be associated with a first retail shelf level and the second image may be associated with a second retail shelf level. The cloud computing system may combine the first image and the second image by aligning the first retail shelf level and the second retail shelf level based on the product indicated in the first shelf level of the first image and the product indicated in the second shelf level of the second image. For example, the first image may indicate five shelves with a particular product on one of the five shelves, and the second image may indicate six shelves with the same particular product on one of the six shelves. In this case, that particular product indicated in both images may be used as an anchor to align a same shelf level between both images. Thus, the cloud computing system may combine the first image and the second image by forming a combined retail shelf level based on the first image and the second image.

In some aspects, multiple images may be captured of a shelf or aisle by a hand-held camera due to a limited resolution of the camera, and/or a field of view restricted by physical boundaries of a retail store. Image stitching may be used to remove duplicate regions across images and to generate meaningful values for some metrics which depend on an absolute position of products like location, shelf level, etc.

Traditional stitching techniques use key points identified in images, but in a retail environment, these traditional stitching techniques may be inadequate. In the retail environment, images may include multiple shelf rows of similar looking products. If using the traditional stitching techniques, similar key points may be found in multiple images, even when the key points are spatially associated with different products. The similar key points in the multiple images may lead to wrongly matched key points when the images are stitched together. As a result, the stitched images may be misaligned, and/or may include excess products or may skip products altogether.

For example, a soda bottle may include a brand name and a brand logo. However, an image may include multiple shelf rows of soda bottles with similar packaging, even though the multiple shelf rows may include different flavors of soda. As a result, using the traditional stitching techniques, an image may be attempted to be stitched with another image using the brand name and/or the brand logo, but similarities between the different flavors of soda bottles may lead to misaligned stitched images and/or stitched images that do not accurately reflect the actual products that are on the shelves.

As another example, discernable features across products of a brand are often minimal, such as a small text indicating a size or flavor (e.g., decaf versus regular, 24ct versus 36ct, etc.). As a result, traditional stitching techniques are not able to accurately identify key points of images to match to determine overlapping regions between images of products.

In some aspects, the cloud computing system may combine (or stitch) together the images based on product recognition. For example, the cloud computing system may identify a cherry flavor beverage in the first image, and in the second image, the cloud computing system may look for the cherry flavor beverage and not a general beverage associated with a same brand name and/or brand logo of the cherry flavor beverage. As a result, image stitching may be specifically tailored to the retail environment, in which the images contain multiple shelves of products with similar dimensions and/or features.

In some aspects, images may be stitched together based on product recognition which are used as the key points. The images may be deconstructed into sections, and the sections may be further split into shelf levels. Similar looking shelf levels containing products across the images may be identified, and then merged together and aligned as if the products were on a same shelf level. Stitched or de-duplicated shelf levels may be constructed back into disjoint sections, which may then be used to perform the image analysis.

As shown by reference number 420, the cloud computing system may perform the image analysis on the combined image. The cloud computing system may perform the image analysis using models based on artificial intelligence, machine learning, computer vision, image recognition, heuristic rules, and/or related techniques. The cloud computing system may identify products that are present or not present in the retail store (e.g., out-of-stock products) based on the image analysis, as well as problems associated with the products (e.g., missing products or misplaced products) based on the image analysis.

As shown by reference number 425, the cloud computing system may generate and transmit an action recommendation to a retail system based on the image analysis. In some aspects, the action recommendation may be associated with a task to be performed with respect to products in the retail store. The action recommendation may be based on shelf analysis derived from the image analysis, and may include a specific set of tasks that are prioritized and most relevant to sales representatives at the shelves, retail managers at corporate offices, etc.

Examples of such action recommendations may include restocking ‘Lays potato chips classic- 12oz’ on a retail shelf that is currently out-of-stock on the retail shelf, replacing a shelf fixture to increase a capacity from four shelf levels to five shelf levels, placing an order to deliver 24 packs of ‘Cheetos flaming hot -6oz’ to the retail store, placing an order to deliver signage for a ‘Buy 2 Offer’ to the retail store, etc.

In some aspects, the action recommendation may maximize a shelf impact score, which may be based on a revenue impact as a result of performing the action recommendation and a first corresponding weight, a non-monetary impact as a result of performing the action recommendation and a second corresponding weight, and/or a determination as to whether the action recommendation is actionable and a third corresponding weight. For example, the shelf impact score may be represented by w.o.1*O.1 + w.o.2*O.2 + w.0.3*O3, where O.1 represents a revenue impact as a result of acting on the recommendation, O.2 represents a non-monetary impact as a result of acting on a recommendation such as improving a customer relationship, O.3 represents whether the recommendation is actionable, and w.o represent weights respectively for each component.

In some aspects, the cloud computing system may generate the action recommendation based on various shelf action inputs. The shelf action inputs may be provided to a machine learning model to determine the recommendation.

In some aspects, the shelf action inputs may include a characteristic of a retail shelf holding products in the retail store. As an example, the cloud computing system may have an ability to reason about a type of shelf merchandising compliance issue. For example, if there are a number of out-of-stock items, but a retail shelf structure present is smaller than expected, an action recommendation may be to increase a capacity of the retail shelf itself. In another case, the retail shelf may have sufficient capacity to fit more products, in which case the action recommendation may be to fill the out-of-stock products. The cloud computing system may have the capability to reason about a size of the retail shelf in relation to the out-of-stock products, which may enable a more specific action recommendation.

In some aspects, the shelf action inputs may include supply chain data associated with the products in the retail store. The supply chain data may indicate whether products were delivered to a retail store or warehouse. As an example, if an out-of-stock product is delivered to the retail store, the action recommendation may be to bring the product from a backroom to a retail shelf. On the other hand, if the supply chain data indicates that the product is not currently in the retail store, the action recommendation may be to order the product or perform other supply chain issues.

In some aspects, the shelf action inputs may include spatio-temporal trend data associated with the products in the retail store. The spatio-temporal trend data may be useful for particular issues that occur in the retail store. For example, the spatio-temporal trend data may indicate that a particular product is out-of-stock in other neighboring retail stores as well, which may indicate a supply chain issue, and the action recommendation may be related to mitigating the supply chain issue.

In some aspects, the shelf action inputs may include a remediation time associated with the products in the retail store. Each type of activity may be associated with a different amount of time, and often tradeoffs may be made by a representative who visits numerous retail stores to detail with issues to be fixed at the retail stores. Thus, the action recommendation may be to prioritize certain retail stores over other retail stores in view of expected times to fix the issues at the retail stores. Further, the shelf action inputs may include a projected impact, as each issue may have a different projected impact in terms of lost revenue and other parameters.

As indicated above, FIG. 4 is provided as an example. Other examples may differ from what is described with respect to FIG. 4.

As indicated above, FIGS. 1-4 are provided as examples. Other examples may differ from what is described with regard to FIGS. 1-4. The number and arrangement of devices shown in FIGS. 1-4 are provided as an example. In practice, there may be additional devices, fewer devices, different devices, or differently arranged devices than those shown in FIGS. 1-4. Furthermore, two or more devices shown in FIGS. 1-4 may be implemented within a single device, or a single device shown in FIGS. 1-4 may be implemented as multiple, distributed devices. Additionally, or alternatively, a set of devices (e.g., one or more devices) shown in FIGS. 1-4 may perform one or more functions described as being performed by another set of devices shown in FIGS. 1-4.

In some aspects, for a machine learning based solution, a time to market may be based at least in part on data procurement and model training. During data procurement and model training, data annotation may be a time-intensive task when using a machine learning platform to train and test models. Annotation datasets in a retail domain may be time consuming due to relatively dense packing of products with fine grained labels in a scene. Further, a cost of labor and time to annotate data may increase exponentially with different categories of products from various geographic regions.

In some aspects, synthetic data generation and augmentation may be performed using a three dimensional (3D) graphics engine. Studio images of products from online marketplaces and digital media may be used for bootstrapping the model training. A texture, lighting, and/or viewing angle of a product may be simulated using the 3D graphics engine, such that synthetic samples (e.g., the studio images) may resemble products as seen in real life at the store, which may otherwise be difficult to emulate with two dimensional (2D) image processing techniques.

In some aspects, when the product on the shelf is different from a thumbnail image of the product, such as when the product is promoted, an image of the product in real-life on the shelf may be leveraged to generate a data set of a plurality of samples (e.g., thousands of samples). The image of the product in real-life may not be ideal when compared to thumbnail images of products, which are often captured in a controlled environment. As a result, a combination of studio images and real-life images may be used for training machine learning models. An image analysis may be based on a machine learning model, which may be trained using synthetic images of products (which may be based on the studio images) and the real-life image of products.

In some aspects, data on which machine learning models are evaluated may be important, similar to training data sets, when images are expected to be captured in an unforeseen environment in production. In some aspects, a machine learning model evaluation framework may be based at least in part on the synthetic data generated using the 3D graphics engine. By using the synthetic data, varied test data may be generated that encapsulates different scenes present in different locations (e.g., convenience stores or supermarkets) and views captured by users. The varied test data may improve a readiness of a machine learning model to be deployed in production, especially with little to no room for manual intervention to supplement or review machine learning model predictions.

FIG. 5 is a diagram of an example environment 500 in which systems and/or methods described herein may be implemented. As shown in FIG. 5, environment 500 may include a cloud computing system 502. The cloud computing system 502 may include one or more elements 503-513, as described in more detail below. As further shown in FIG. 5, environment 500 may include a client device 515, an edge computing system 520, a retail system 525, a developer system 530, and/or a network 540. Devices and/or elements of environment 500 may interconnect via wired connections and/or wireless connections.

The cloud computing system 502 includes computing hardware 503, a resource management component 504, a host operating system (OS) 505, and/or one or more virtual computing systems 506. The resource management component 504 may perform virtualization (e.g., abstraction) of computing hardware 503 to create the one or more virtual computing systems 506. Using virtualization, the resource management component 504 enables a single computing device (e.g., a computer, a server, and/or the like) to operate like multiple computing devices, such as by creating multiple isolated virtual computing systems 506 from computing hardware 503 of the single computing device. In this way, computing hardware 503 can operate more efficiently, with lower power consumption, higher reliability, higher availability, higher utilization, greater flexibility, and lower cost than using separate computing devices.

Computing hardware 503 includes hardware and corresponding resources from one or more computing devices. For example, computing hardware 503 may include hardware from a single computing device (e.g., a single server) or from multiple computing devices (e.g., multiple servers), such as multiple computing devices in one or more data centers. As shown, computing hardware 503 may include one or more processors 507, one or more memories 508, one or more storage components 509, and/or one or more networking components 510. Examples of a processor, a memory, a storage component, and a networking component (e.g., a communication component) are described elsewhere herein.

The resource management component 504 includes a virtualization application (e.g., executing on hardware, such as computing hardware 503) capable of virtualizing computing hardware 503 to start, stop, and/or manage one or more virtual computing systems 506. For example, the resource management component 504 may include a hypervisor (e.g., a bare-metal or Type 1 hypervisor, a hosted or Type 2 hypervisor, and/or the like) or a virtual machine monitor, such as when the virtual computing systems 506 are virtual machines 511. Additionally, or alternatively, the resource management component 504 may include a container manager, such as when the virtual computing systems 506 are containers 512. In some implementations, the resource management component 504 executes within and/or in coordination with a host operating system 505.

A virtual computing system 506 includes a virtual environment that enables cloud-based execution of operations and/or processes described herein using computing hardware 503. As shown, a virtual computing system 506 may include a virtual machine 511, a container 512, a hybrid environment 513 that includes a virtual machine and a container, and/or the like. A virtual computing system 506 may execute one or more applications using a file system that includes binary files, software libraries, and/or other resources required to execute applications on a guest operating system (e.g., within the virtual computing system 506) or the host operating system 505.

Although the cloud computing system 502 may include one or more elements 503-513, which may execute within the cloud computing system 502, and/or may be hosted within the cloud computing system 502, in some implementations, the cloud computing system 502 may not be cloud-based (e.g., may be implemented outside of a cloud computing system) or may be partially cloud-based. For example, the cloud computing system 502 may include one or more devices, such as device 600 of FIG. 6, which may include a standalone server or another type of computing device. The cloud computing system 502 may perform one or more operations and/or processes described in more detail elsewhere herein.

The client device 515 includes one or more devices capable of receiving, generating, storing, processing, and/or providing information associated with image analysis of products in a retail store, as described elsewhere herein. The client device 515 may include a communication device and/or a computing device. For example, the client device 515 may include a wireless communication device, a phone such as a smart phone, a mobile phone or a video phone, a user equipment, a laptop computer, a tablet computer, a desktop computer, a television, a gaming console, or a similar type of device. The client device 515 may include a robotic device, that may or may not include autonomous moving capabilities. The client device 515 may include a camera to capture images.

The edge computing system 520 includes one or more devices capable of receiving, generating, storing, processing, providing, and/or routing information associated with image analysis of products in a retail store, as described elsewhere herein. The edge computing system 520 may include a communication device and/or a computing device. For example, the edge computing system 520 may include a server, such as an application server, a client server, a web server, a database server, a host server, a proxy server, a virtual server (e.g., executing on computing hardware), or a server in a cloud computing system.

The retail system 525 includes one or more devices capable of receiving, generating, storing, processing, providing, and/or routing information associated with image analysis of products in a retail store, as described elsewhere herein. The retail system 525 may include a communication device and/or a computing device. For example, the retail system 525 may include a server, such as an application server, a client server, a web server, a database server, a host server, a proxy server, a virtual server (e.g., executing on computing hardware), or a server in a cloud computing system. In some implementations, the retail system 525 includes computing hardware used in a cloud computing environment.

The developer system 530 includes one or more devices capable of receiving, generating, storing, processing, providing, and/or routing information associated with image analysis of products in a retail store, as described elsewhere herein. The developer system 530 may include a communication device and/or a computing device. For example, the developer system 530 may include a server, such as an application server, a client server, a web server, a database server, a host server, a proxy server, a virtual server (e.g., executing on computing hardware), or a server in a cloud computing system. In some implementations, the developer system 530 includes computing hardware used in a cloud computing environment.

Network 540 includes one or more wired and/or wireless networks. For example, network 540 may include a cellular network, a public land mobile network (PLMN), a local area network (LAN), a wide area network (WAN), a metropolitan area network, a telephone network, a private network, the Internet, and/or the like, and/or a combination of these or other types of networks. The network 540 enables communication among the devices of environment 500.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600, which may correspond to the cloud computing system 502, the client device 515, the edge computing system 520, a retail system 525, and/or the developer system 530. In some implementations, the client device 515, the edge computing system 520, a retail system 525, and/or the developer system 530 may include one or more devices 600 and/or one or more components of device 600. As shown in FIG. 6, device 600 may include a bus 610, a processor 620, a memory 630, a storage component 640, an input component 650, an output component 660, and a communication component 670.

Bus 610 includes a component that enables wired and/or wireless communication among the components of device 600. Processor 620 includes a central processing unit, a graphics processing unit, a microprocessor, a controller, a microcontroller, a digital signal processor, a field-programmable gate array, an application-specific integrated circuit, and/or another type of processing component. Processor 620 is implemented in hardware, firmware, or a combination of hardware and software. In some implementations, processor 620 includes one or more processors capable of being programmed to perform a function. Memory 630 includes a random access memory, a read only memory, and/or another type of memory (e.g., a flash memory, a magnetic memory, and/or an optical memory).

Storage component 640 stores information and/or software related to the operation of device 600. For example, storage component 640 may include a hard disk drive, a magnetic disk drive, an optical disk drive, a solid-state disk drive, a compact disc, a digital versatile disc, and/or another type of non-transitory computer-readable medium. Input component 650 enables device 400 to receive input, such as user input and/or sensed inputs. For example, input component 650 may include a touch screen, a keyboard, a keypad, a mouse, a button, a microphone, a switch, a sensor, a global positioning system component, an accelerometer, a gyroscope, and/or an actuator. Output component 660 enables device 600 to provide output, such as via a display, a speaker, and/or one or more light-emitting diodes. Communication component 670 enables device 400 to communicate with other devices, such as via a wired connection and/or a wireless connection. For example, communication component 670 may include a receiver, a transmitter, a transceiver, a modem, a network interface card, and/or an antenna.

Device 600 may perform one or more processes described herein. For example, a non-transitory computer-readable medium (e.g., memory 630 and/or storage component 640) may store a set of instructions (e.g., one or more instructions, code, software code, and/or program code) for execution by processor 620. Processor 620 may execute the set of instructions to perform one or more processes described herein. In some implementations, execution of the set of instructions, by one or more processors 620, causes the one or more processors 620 and/or the device 600 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 6 are provided as an example. Device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

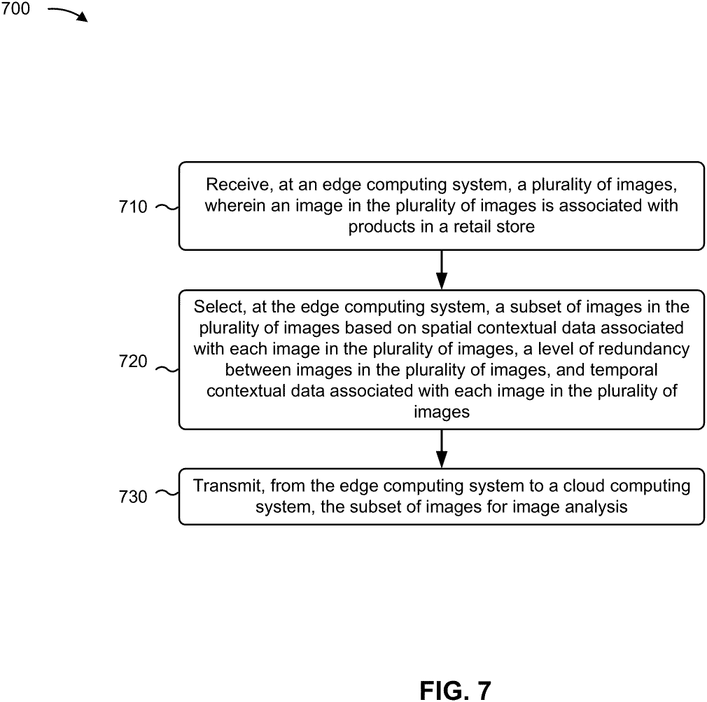

FIG. 7 is a flowchart of an example process 700 associated with image analysis of products in a retail store. In some implementations, one or more process blocks of FIG. 7 may be performed by an edge computing system (e.g., edge computing system 520). In some implementations, one or more process blocks of FIG. 7 may be performed by another device or a group of devices separate from or including the cloud computing system 502, the client device 515, and/or the developer system 530. Additionally, or alternatively, one or more process blocks of FIG. 7 may be performed by one or more components of device 600, such as processor 620, memory 630, storage component 640, input component 650, output component 660, and/or communication component 670.

As shown in FIG. 7, process 700 may include receiving, at an edge computing system, a plurality of images, wherein an image in the plurality of images is associated with products in a retail store (block 710). As further shown in FIG. 7, process 700 may include selecting, at the edge computing system, a subset of images in the plurality of images based on spatial contextual data associated with each image in the plurality of images, a level of redundancy between images in the plurality of images, and temporal contextual data associated with each image in the plurality of images (block 720). As further shown in FIG. 7, process 700 may include transmitting, from the edge computing system to a cloud computing system, the subset of images for image analysis (block 730).

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

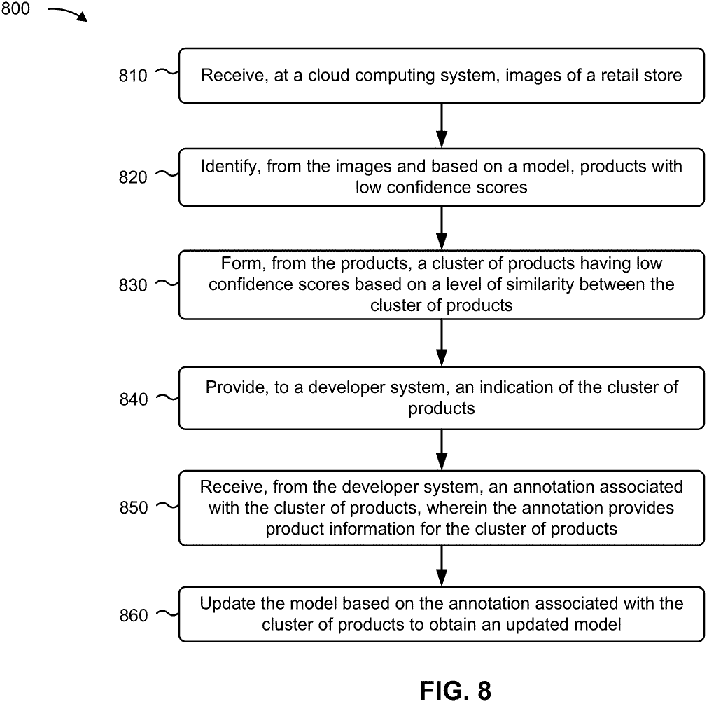

FIG. 8 is a flowchart of an example process 800 associated with image analysis of products in a retail store. In some implementations, one or more process blocks of FIG. 8 may be performed by an edge computing system (e.g., edge computing system 520). In some implementations, one or more process blocks of FIG. 8 may be performed by another device or a group of devices separate from or including the cloud computing system 502, the client device 515, and/or the developer system 530. Additionally, or alternatively, one or more process blocks of FIG. 8 may be performed by one or more components of device 600, such as processor 620, memory 630, storage component 640, input component 650, output component 660, and/or communication component 670.

As shown in FIG. 8 process 800 may include receiving, at a cloud computing system, images of a retail store (block 810). As further shown in FIG. 8, process 800 may include identifying, from the images and based on a model, products with low confidence scores (block 820). As further shown in FIG. 8, process 800 may include forming, from the products, a cluster of products having low confidence scores based on a level of similarity between the cluster of products (block 830). As further shown in FIG. 8, process 800 may include providing, to a developer system, an indication of the cluster of products (block 840). As further shown in FIG. 8, process 800 may include receiving, from the developer system, an annotation associated with the cluster of products, wherein the annotation provides product information for the cluster of products (block 850). As further shown in FIG. 8, process 800 may include updating the model based on the annotation associated with the cluster of products to obtain an updated model (block 860).

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

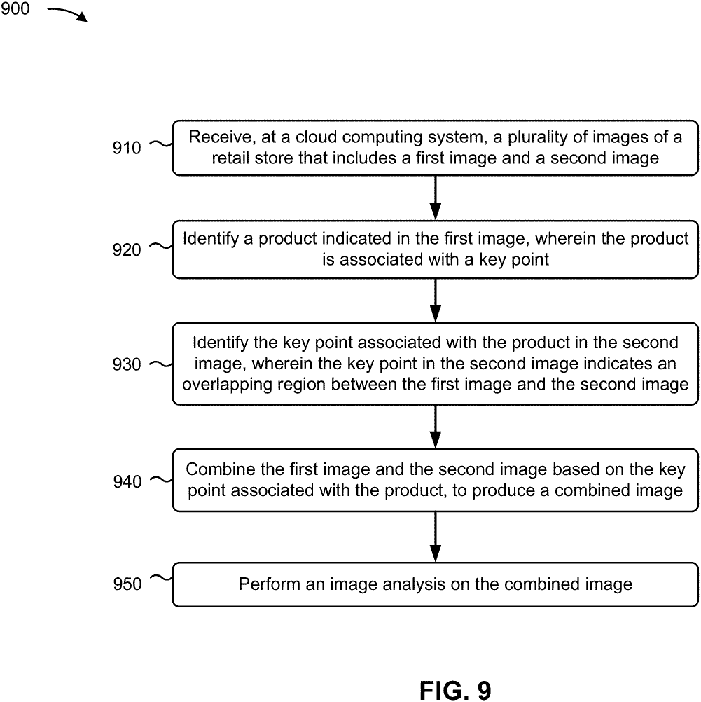

FIG. 9 is a flowchart of an example process 900 associated with image analysis of products in a retail store. In some implementations, one or more process blocks of FIG. 9 may be performed by an edge computing system (e.g., edge computing system 520). In some implementations, one or more process blocks of FIG. 9 may be performed by another device or a group of devices separate from or including the cloud computing system 502, the client device 515, and/or the developer system 530. Additionally, or alternatively, one or more process blocks of FIG. 9 may be performed by one or more components of device 600, such as processor 620, memory 630, storage component 640, input component 650, output component 660, and/or communication component 670.

As shown in FIG. 9 process 900 may receiving, at a cloud computing system, a plurality of images of a retail store that includes a first image and a second image (block 910). As further shown in FIG. 9, process 900 may include identifying a product indicated in the first image, wherein the product is associated with a key point (block 920). As further shown in FIG. 9, process 900 may include identifying the key point associated with the product in the second image, wherein the key point in the second image indicates an overlapping region between the first image and the second image (block 930). As further shown in FIG. 9, process 900 may include combining the first image and the second image based on the key point associated with the product, to produce a combined image (block 940). As further shown in FIG. 9, process 900 may include performing an image analysis on the combined image (block 950).

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

The following provides an overview of some aspects of the present disclosure:

Aspect 1: A method, comprising: receiving, at an edge computing system, a plurality of images, wherein an image in the plurality of images is associated with products in a retail store; selecting, at the edge computing system, a subset of images in the plurality of images based on spatial contextual data associated with each image in the plurality of images, a level of redundancy between images in the plurality of images, and temporal contextual data associated with each image in the plurality of images; and transmitting, from the edge computing system to a cloud computing system, the subset of images for image analysis.

Aspect 2: The method of Aspect 1, wherein selecting the subset of images comprises: identifying the spatial contextual data associated with each image in the plurality of images, wherein the spatial contextual data indicates a relative spatial location within the retail store associated with each image; and discarding images having relative spatial locations that do not satisfy a relative distance threshold in relation to other images having relative spatial locations.

Aspect 3: The method of Aspect 1, wherein selecting the subset of images comprises: identifying the spatial contextual data associated with each image in the plurality of images, wherein the spatial contextual data indicates a relative spatial location within the retail store associated with each image; comparing the spatial contextual data associated with each image to a product space plan associated with the retail store, wherein the product space plan indicates areas within the retail store associated with products; and discarding images that correspond to areas within the retail store that are not associated with the products, based on comparing the spatial contextual data associated with the images to the product space plan.

Aspect 4: The method of Aspect 1, wherein selecting the subset of images comprises: determining a level of redundancy between images in the plurality of images; and discarding images having levels of redundancy that do not satisfy a threshold in relation to other images in the plurality of images.

Aspect 5: The method of Aspect 1, wherein selecting the subset of images comprises: identifying the temporal contextual data associated with each image in the plurality of images, wherein the temporal contextual data indicates a time associated with each image; and removing images associated with times that do not satisfy a threshold in relation to other images in the plurality of images.

Aspect 6: The method of Aspect 1, further comprising: discarding a remaining subset of images in the plurality of images based on the spatial contextual data associated with each image in the plurality of images, the level of redundancy between images in the plurality of images, and the temporal contextual data associated with each image in the plurality of images.

Aspect 7: A method of Aspect 1, wherein selecting the subset of images comprises selecting the subset of images based on customer criteria that defines a portion of the plurality of images to be selected.

Aspect 8: The method of Aspect 1, wherein receiving the plurality of images comprises receiving the plurality of images from a mobile device.

Aspect 9: The method of Aspect 1, wherein receiving the plurality of images comprises receiving the plurality of images from a robotic device configured to move autonomously within the retail store and capture the plurality of images within the retail store.

Aspect 10: The method of Aspect 1, wherein the image analysis on the subset of images is associated with a detection of one or more of: an out-of-stock product, a misplaced product, or a missing product.

Aspect 11: The method of Aspect 1, wherein the image analysis is based on a machine learning model, wherein the machine learning model is trained using synthetic images of products and real-life image of products, and wherein the synthetic images of products are based on two dimensional images of products and a simulation of textures, lightings, and viewing angles for the products using a three dimensional graphics engine.

Aspect 12: A method, comprising: receiving, at a cloud computing system, images of a retail store; identifying, from the images and based on a model, products with low confidence scores; forming, from the products, a cluster of products having low confidence scores based on a level of similarity between the cluster of products; providing, to a developer system, an indication of the cluster of products; receiving, from the developer system, an annotation associated with the cluster of products, wherein the annotation provides product information for the cluster of products; and updating the model based on the annotation associated with the cluster of products to obtain an updated model.

Aspect 13: The method of Aspect 12, further comprising: receiving an image that includes a product associated with the cluster of products; and identifying the product based on the updated model.

Aspect 14: The method of Aspect 12, wherein the indication of the cluster of products is a visual indication of the cluster of products.

Aspect 15: The method of Aspect 12, wherein identifying the products with the low confidence scores comprises: comparing a product package for a given product to a set of product packaging attributes, wherein the set of product packaging attributes are associated with a manufacturer of the given product and indicate product packaging regions having an increased likelihood of providing product information; and determining that a similarity level between the product package for the given product and the set of attributes does not satisfy a threshold.

Aspect 16: The method of Aspect 12, wherein the images are associated with products sold in different retail stores across multiple geographic regions.

Aspect 17: The method of Aspect 12, wherein the products with the low confidence scores are new products.

Aspect 18: The method of Aspect 12, wherein the products with the low confidence scores are existing products with new packaging.

Aspect 19: The method of Aspect 12, wherein receiving the images comprises receiving the images from a client device.

Aspect 20: The method of Aspect 12, wherein receiving the images comprises receiving the images from a client device via an edge computing system associated with the retail store.

Aspect 21: A method, comprising: receiving, at a cloud computing system, a plurality of images of a retail store that includes a first image and a second image; identifying a product indicated in the first image, wherein the product is associated with a key point; identifying the key point associated with the product in the second image, wherein the key point in the second image indicates an overlapping region between the first image and the second image; combining the first image and the second image based on the key point associated with the product, to produce a combined image; and performing an image analysis on the combined image.

Aspect 22: The method of Aspect 21, wherein identifying the product comprises identifying one or more of: a stock keeping unit associated with the product, a brand associated with the product, or a Universal Product Code description associated with the product.

Aspect 23: The method of Aspect 21, wherein identifying the product comprises identifying the product using a machine learning model.

Aspect 24: The method of Aspect 21, wherein the first image of the product is associated with a first retail shelf level and the second image is associated with a second retail shelf level, and combining the first image and the second image comprises aligning the first retail shelf level and the second retail shelf level based on the product indicated in the first shelf level of the first image and the product indicated in the second shelf level of the second image.

Aspect 25: The method of Aspect 21, wherein the first image of the product is associated with a first retail shelf level and the second image is associated with a second retail shelf level, and combining the first image and the second image comprises forming a combined retail shelf level based on the first image and the second image.

Aspect 26: The method of Aspect 21, further comprising: determining an ordering associated with the first image and the second image based on an overlap in information between the first image and the second image, and wherein combining the first image and the second image comprises combining the first image and the second image based on the ordering associated with the first image and the second image.

Aspect 27: The method of Aspect 21, further comprising: providing a recommendation based on the image analysis.

Aspect 28: The method of Aspect 27, wherein the recommendation is associated with a task to be performed with respect to products in the retail store.

Aspect 29: The method of Aspect 27, wherein the recommendation maximizes a shelf impact score that is based on: a revenue impact as a result of acting on the recommendation and a first corresponding weight, a non-monetary impact as a result of acting on the recommendation and a second corresponding weight, and a determination as to whether the recommendation is actionable and a third corresponding weight.

Aspect 30: The method of Aspect 27, wherein the recommendation is based on one of more of: a characteristic of a retail shelf holding products in the retail store, supply chain data associated with the products in the retail store, spatio-temporal trend data associated with the products in the retail store, or a remediation time associated with the products in the retail store.

Aspect 31: The method of Aspect 21, wherein receiving the plurality images comprises receiving the plurality of images from a client device.

Aspect 32: The method of Aspect 21, wherein receiving the plurality images comprises receiving the plurality of images from a client device via an edge computing system associated with the retail store.

Aspect 33: An apparatus at a device, comprising a processor; memory coupled with the processor; and instructions stored in the memory and executable by the processor to cause the apparatus to perform the method of one or more aspects of aspects 1-32.

Aspect 34: A device, comprising a memory and one or more processors coupled to the memory, the memory and the one or more processors configured to perform the method of one or more aspects of aspects 1-32.

Aspect 35: An apparatus, comprising at least one means for performing the method of one or more aspects of aspects 1-32.

Aspect 36: A non-transitory computer-readable medium storing code, the code comprising instructions executable by a processor to perform the method of one or more aspects of aspects 1-32.

Aspect 37: A non-transitory computer-readable medium storing a set of instructions, the set of instructions comprising one or more instructions that, when executed by one or more processors of a device, cause the device to perform the method of one or more aspects of aspects 1-32.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of′ a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of′).

What is claimed is:

1. A method, comprising:
receiving, at an edge computing system, a plurality of images, wherein an image in the plurality of images is associated with products in a retail store;
selecting, at the edge computing system, a subset of images in the plurality of images based on spatial contextual data associated with each image in the plurality of images, a level of redundancy between images in the plurality of images, and temporal contextual data associated with each image in the plurality of images; and
transmitting, from the edge computing system to a cloud computing system, the subset of images for image analysis.

2. The method of claim 1, wherein selecting the subset of images comprises:
identifying the spatial contextual data associated with each image in the plurality of images, wherein the spatial contextual data indicates a relative spatial location within the retail store associated with each image; and
discarding images having relative spatial locations that do not satisfy a relative distance threshold in relation to other images having relative spatial locations.

3. The method of claim 1, wherein selecting the subset of images comprises:
identifying the spatial contextual data associated with each image in the plurality of images, wherein the spatial contextual data indicates a relative spatial location within the retail store associated with each image;
comparing the spatial contextual data associated with each image to a product space plan associated with the retail store, wherein the product space plan indicates areas within the retail store associated with products; and
discarding images that correspond to areas within the retail store that are not associated with the products, based on comparing the spatial contextual data associated with the images to the product space plan.

4. The method of claim 1, wherein selecting the subset of images comprises:
determining a level of redundancy between images in the plurality of images; and
discarding images having levels of redundancy that do not satisfy a threshold in relation to other images in the plurality of images.

5. The method of claim 1, wherein selecting the subset of images comprises:
identifying the temporal contextual data associated with each image in the plurality of images, wherein the temporal contextual data indicates a time associated with each image; and
removing images associated with times that do not satisfy a threshold in relation to other images in the plurality of images.

6. The method of claim 1, further comprising:
discarding a remaining subset of images in the plurality of images based on the spatial contextual data associated with each image in the plurality of images, the level of redundancy between images in the plurality of images, and the temporal contextual data associated with each image in the plurality of images.

7. A method of claim 1, wherein selecting the subset of images comprises selecting the subset of images based on customer criteria that defines a portion of the plurality of images to be selected.

8. The method of claim 1, wherein receiving the plurality of images comprises:
receiving the plurality of images from a mobile device, or
receiving the plurality of images from a robotic device configured to move autonomously within the retail store and capture the plurality of images within the retail store.

9. The method of claim 1, wherein the image analysis on the subset of images is associated with a detection of one or more of: an out-of-stock product, a misplaced product, or a missing product.

10. The method of claim 1, wherein the image analysis is based on a machine learning model, wherein the machine learning model is trained using synthetic images of products and real-life image of products, and wherein the synthetic images of products are based on two dimensional images of products and a simulation of textures, lightings, and viewing angles for the products using a three dimensional graphics engine.

11. A method, comprising:
receiving, from a client device at a cloud computing system, images of a retail store;
identifying, from the images and based on a model, products with low confidence scores;
forming, from the products, a cluster of products having low confidence scores based on a level of similarity between the cluster of products;
providing, to a developer system, an indication of the cluster of products;
receiving, from the developer system, an annotation associated with the cluster of products, wherein the annotation provides product information for the cluster of products; and
updating the model based on the annotation associated with the cluster of products to obtain an updated model.

12. The method of claim 11, further comprising:
receiving an image that includes a product associated with the cluster of products; and
identifying the product based on the updated model.

13. The method of claim 11, wherein the indication of the cluster of products is a visual indication of the cluster of products, and wherein the products with the low confidence scores are new products, or wherein the products with the low confidence scores are existing products with new packaging.

14. The method of claim 11, wherein identifying the products with the low confidence scores comprises:
comparing a product package for a given product to a set of product packaging attributes, wherein the set of product packaging attributes are associated with a manufacturer of the given product and indicate product packaging regions having an increased likelihood of providing product information; and
determining that a similarity level between the product package for the given product and the set of attributes does not satisfy a threshold.

15. A method, comprising:
receiving, at a cloud computing system, a plurality of images of a retail store that includes a first image and a second image;
identifying a product indicated in the first image, wherein the product is associated with a key point;
identifying the key point associated with the product in the second image, wherein the key point in the second image indicates an overlapping region between the first image and the second image;
combining the first image and the second image based on the key point associated with the product, to produce a combined image; and
performing an image analysis on the combined image.

16. The method of claim 15, wherein identifying the product comprises:
identifying one or more of: a stock keeping unit associated with the product, a brand associated with the product, or a Universal Product Code description associated with the product; or
identifying the product using a machine learning model.

17. The method of claim 15, wherein the first image of the product is associated with a first retail shelf level and the second image is associated with a second retail shelf level, and combining the first image and the second image comprises aligning the first retail shelf level and the second retail shelf level based on the product indicated in the first shelf level of the first image and the product indicated in the second shelf level of the second image.

18. The method of claim 15, wherein the first image of the product is associated with a first retail shelf level and the second image is associated with a second retail shelf level, and combining the first image and the second image comprises forming a combined retail shelf level based on the first image and the second image.

19. The method of claim 15, further comprising:
determining an ordering associated with the first image and the second image based on an overlap in information between the first image and the second image, and
wherein combining the first image and the second image comprises combining the first image and the second image based on the ordering associated with the first image and the second image.

20. The method of claim 15, further comprising:
providing a recommendation based on the image analysis, wherein:
the recommendation is associated with a task to be performed with respect to products in the retail store;
the recommendation maximizes a shelf impact score that is based on: a revenue impact as a result of acting on the recommendation and a first corresponding weight, a non-monetary impact as a result of acting on the recommendation and a second corresponding weight, and a determination as to whether the recommendation is actionable and a third corresponding weight; or
the recommendation is based on one of more of: a characteristic of a retail shelf holding products in the retail store, supply chain data associated with the products in the retail store, spatio-temporal trend data associated with the products in the retail store, or a remediation time associated with the products in the retail store.
